(19) United States
(12) Patent Application Publication
(10) Pub. No.: US 2022/0122292 A1
(43) Pub. Date: Apr. 21, 2022

(54) POSE DETERMINATION METHOD AND DEVICE, ELECTRONIC DEVICE AND STORAGE MEDIUM

(71) Applicant: SHENZHEN SENSETIME TECHNOLOGY CO., LTD., Shenzhen (CN)

(72) Inventors: Chengkai ZHU, Shenzhen (CN); Yan FENG, Shenzhen (CN); Wei WU, Shenzhen (CN); Junjie YAN, Shenzhen (CN); Sirui LIN, Shenzhen (CN)

(21) Appl. No.: 17/563,744

(22) Filed: Dec. 28, 2021

Related U.S. Application Data
(63) Continuation of application No. PCT/CN2019/123646, filed on Dec. 6, 2019.

(30) Foreign Application Priority Data
Jul. 31, 2019 (CN) 201910701860.0

(51) Int. Cl. G06T 7/73; G06N 3/04; G06N 3/08; G06T 7/80

(52) U.S. Cl. CPC G06T 7/74; G06N 3/0454; G06N 3/08; G06T 2207/30232; G06T 2207/30244; G06T 2207/20081; G06T 2207/20084; G06T 7/80

(57) ABSTRACT

A pose determination method and device, an electronic device and a storage medium are provided. The method includes that: a reference image matched with an image to be processed is acquired; key point extraction processing is performed on the image to be processed and the reference image to obtain a first key point in the image to be processed and a second key point corresponding to the first key point in the reference image respectively; and a target pose of an image acquisition device when the image to be processed is collected by the image acquisition device is determined according to a corresponding relationship between the first key point and the second key point and a reference pose corresponding to the reference image.

### CROSS-REFERENCE TO RELATED APPLICATION

This is a continuation application of International Patent Application No. PCT/CN2019/123646, filed on Dec. 6, 2019, which claims priority to Chinese Patent Application No. 201910701860.0, filed to the Chinese Patent Office on Jul. 31, 2019 and entitled “Pose Determination Method and Device, Electronic Device and Storage Medium”. The disclosures of International Patent Application No. PCT/CN2019/123646 and Chinese Patent Application No. 201910701860.0 are hereby incorporated by reference in their entireties.

### BACKGROUND

Camera calibration is a basic issue of visual positioning. Both calculation of a target geographical position and acquisition of a visual region of a camera require the camera to be calibrated. In a related art, a common calibration algorithm only considers the condition that a position of a camera is fixed. However, present monitoring cameras in cities include many rotatable cameras.

### SUMMARY

The disclosure relates to the technical field of computers, and particularly to a pose determination method and device, an electronic device and a storage medium.

The disclosure discloses a pose determination method and device, an electronic device and a storage medium.

According to an aspect of the disclosure, a pose determination method is provided, which may include the following operations.

A reference image matched with an image to be processed is acquired, the image to be processed and the reference image being acquired by an image acquisition device, the reference image having a corresponding reference pose and the reference pose being configured to represent a pose of the image acquisition device when the reference image is collected by the image acquisition device.

Key point extraction processing is performed on the image to be processed and the reference image to obtain a first key point in the image to be processed and a second key point, corresponding to the first key point, in the reference image respectively.

A target pose of the image acquisition device when the image to be processed is collected by the image acquisition device is determined according to a corresponding relationship between the first key point and the second key point and the reference pose corresponding to the reference image.

According to an aspect of the disclosure, a pose determination device is provided, which may include an acquisition module, a first extraction module and a first determination module.

The acquisition module may be configured to acquire a reference image matched with an image to be processed, the image to be processed and the reference image being acquired by an image acquisition device, the reference image having a corresponding reference pose and the reference pose being configured to represent a pose of the image acquisition device when the reference image is collected by the image acquisition device.

The first extraction module may be configured to perform key point extraction processing on the image to be processed and the reference image to obtain a first key point in the image to be processed and a second key point, corresponding to the first key point, in the reference image respectively.

The first determination module may be configured to determine a target pose of the image acquisition device when the image to be processed is collected by the image acquisition device according to a corresponding relationship between the first key point and the second key point and the reference pose corresponding to the reference image.

According to an aspect of the disclosure, an electronic device is provided, which may include:

a processor; and

a memory, configured to store instructions executable for the processor.

The processor may be configured to execute the pose determination method.

According to an aspect of the disclosure, a non-transitory computer-readable storage medium is provided, in which computer program instructions may be stored, the computer program instructions being executed by a processor to implement the pose determination method.

According to an aspect of the disclosure, a computer program is provided, which may include computer-readable codes, the computer-readable codes running in an electronic device to enable a processor of the electronic device to execute the pose determination method.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 illustrates a flowchart of a pose determination method according to embodiments of the disclosure.

FIG. 2 illustrates a flowchart of a pose determination method according to embodiments of the disclosure.

FIG. 3 illustrates a schematic diagram of target points according to embodiments of the disclosure.

FIG. 4 illustrates a flowchart of a pose determination method according to embodiments of the disclosure.

FIG. 5 illustrates a schematic diagram of training a neural network according to embodiments of the disclosure.

FIG. 6 illustrates a schematic diagram of application of a pose determination method according to embodiments of the disclosure.

FIG. 7 illustrates a block diagram of a pose determination device according to embodiments of the disclosure.

FIG. 8 illustrates a block diagram of an electronic device according to embodiments of the disclosure.

FIG. 9 illustrates a block diagram of an electronic device according to embodiments of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

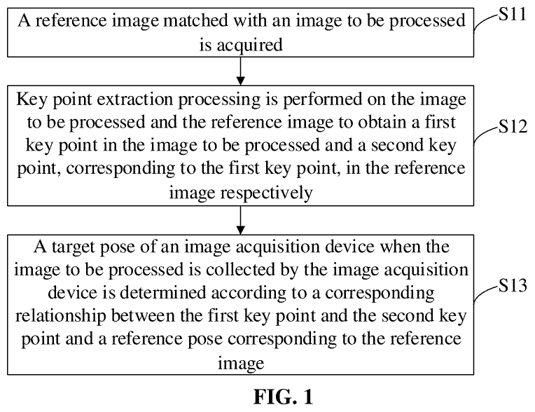

FIG. 1 illustrates a flowchart of a pose determination method according to embodiments of the disclosure. As shown in FIG. 1, the method includes the following operations.

In S11, a reference image matched with an image to be processed is acquired. The image to be processed and the reference image are acquired by an image acquisition device. The reference image has a corresponding reference pose and the reference pose is configured to represent a pose of the image acquisition device when the reference image is collected by the image acquisition device.

In S12, key point extraction processing is performed on the image to be processed and the reference image to obtain a first key point in the image to be processed and a second key point, corresponding to the first key point, in the reference image respectively.

In S13, a target pose of the image acquisition device when the image to be processed is collected by the image acquisition device is determined according to a corresponding relationship between the first key point and the second key point and the reference pose corresponding to the reference image.

According to the pose determination method of the embodiments of the disclosure, the reference image matched with the image to be processed may be selected, and the pose corresponding to the image to be processed may be determined according to the pose corresponding to the reference image, so that the image acquisition device may be calibrated to a corresponding pose when rotating or being displaced to be rapidly adapted to a new monitoring scenario.

In a possible implementation mode, the pose determination method may be used for determining a pose of the image acquisition device such as a camera, a video camera, a monitor and the like. For example, the pose determination method may be used for determining a pose of a camera of a monitoring system, an access control system and the like. In case of pose changing, such as displacement or rotation, of the image acquisition device, for example, when the monitoring camera rotates, a pose of the image acquisition device after pose changing may be efficiently determined. An application field of the pose determination method is not limited in the disclosure.

In a possible implementation mode, the method may be executed by a terminal device. The terminal device may be User Equipment (UE), a mobile device, a user terminal, a terminal, a cell phone, a cordless phone, a Personal Digital Assistant (PDA), a handheld device, a computing device, a vehicle device, a wearable device and the like. The method may be implemented in a manner that a processor calls the computer-readable instructions stored in a memory. Or, the method may be executed through a server.

In a possible implementation mode, at least one first image may be acquired through the image acquisition device at a preset position, and the reference image matched with the image to be processed is selected from the at least one first image. The image acquisition device may be a rotatable camera, for example, a spherical camera for monitoring. The image acquisition device may rotate along a pitching direction and/or a yawing direction, and the image acquisition device may acquire one or more first images in a rotation process. In other embodiments, one reference image may be acquired through the image acquisition device. No limits are made herein.

In an example, the image acquisition device may rotate 180° in the pitching direction and rotate 360° in the yawing direction. In such case, the image acquisition device may acquire at least one first image in the rotation process, for example, acquiring the first images at an interval of a preset angle. In another example, the image acquisition device may rotate by a preset angle in the pitching direction and/or the yawing direction, and for example, may rotate 10°, 20°, 30°, and the like only. The image acquisition device may acquire one or more first images in the rotation process, for example, acquiring the first images at an interval of a preset angle. For example, the image acquisition device may rotate 20° in the yawing direction and may acquire first images every 5° in a rotation process. In such case, the image acquisition device may acquire a first image when rotating to each of 0°, 5°, 10°, 15° and 20° to acquire totally 5 first images. For another example, the image acquisition device may rotate 10° only in the yawing direction. In such case, the image acquisition device may acquire a first image when rotating to each of 0°, 5° and 10° to acquire totally 3 first images. A reference pose corresponding to each first image includes a rotation matrix and displacement vector of the image acquisition device when the first image is acquired by the image acquisition device. The target pose corresponding to the image to be processed includes a rotation matrix and displacement vector of the image acquisition device when the image to be processed is acquired by the image acquisition device. The reference image is an image, matched with the image to be processed, in the first images. The reference pose corresponding to the reference image includes the rotation matrix and displacement vector of the image acquisition device when the reference image is acquired by the image acquisition device, and the target pose corresponding to the image to be processed includes the rotation matrix and displacement vector of the image acquisition device when the image to be processed is acquired by the image acquisition device.

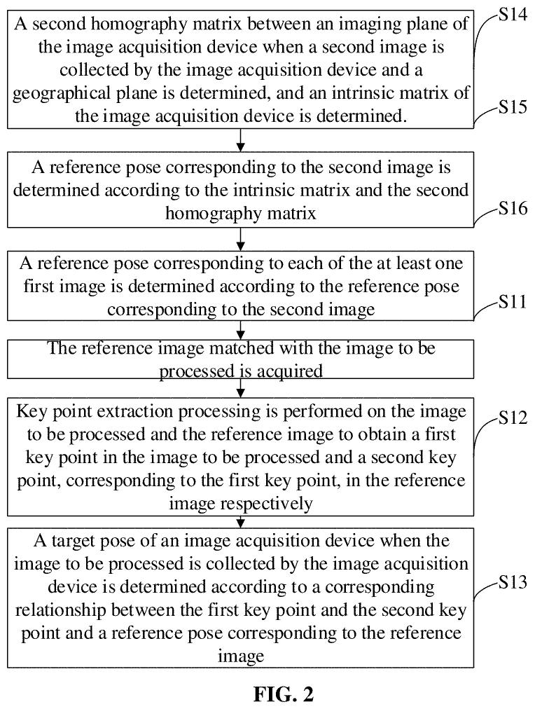

FIG. 2 illustrates a flowchart of a pose determination method according to embodiments of the disclosure. As shown in FIG. 2, the method further includes the following operations.

In S14, a second homography matrix between an imaging plane of the image acquisition device when a second image is collected by the image acquisition device and a geographical plane is determined, and an intrinsic matrix of the image acquisition device is determined. The second image may be any one image in multiple first images and the geographical plane may be a plane where geographical position coordinates of target points are located.

In S15, a reference pose corresponding to the second image is determined according to the intrinsic matrix and the second homography matrix.

In S16, a reference pose corresponding to each of the at least one first image is determined according to the reference pose corresponding to the second image.

In a possible implementation mode, in S14, the image acquisition device may rotate along the pitching direction and/or the yawing direction, and may sequentially acquire the first image in the rotation process. For example, the image acquisition device may be set to be at a certain angle (for example, 1°, 5° and 10°) in the pitching direction, rotate a circle along the yawing direction, and acquire a first image at an interval of a certain angle (for example, 1°, 5° and 10°) in the rotation process. After rotating a circle, the image acquisition device may be regulated by a certain angle (for example, 1°, 5° and 10°) in the pitching direction, rotate a circle along the yawing direction, and acquire a first image at an interval of a certain angle in the rotation process. The angle in the pitching direction may be continued to be regulated according to the abovementioned manner and first images are acquired in a process of rotating a circle along the yawing direction, until the angle in the pitching direction is regulated by 180°. Or, when the image acquisition device may rotate by the preset angle in the pitching direction and/or the yawing direction, the first images may be sequentially acquired.

In a possible implementation mode, any one of the first images acquired in the abovementioned process may be determined as the second image. When the reference pose corresponding to each first image is sequentially determined, the selected second image is determined as a first image to be processed during processing of determining the reference poses of the at least one first image. After the reference pose corresponding to the second image is determined, the reference poses of the other first images are determined according to the reference pose corresponding to the second image. For example, the first one of the first images may be determined as the second image, and the second image may be calibrated (namely the pose of the image acquisition device, when the second image is acquired by the image acquisition device, is calibrated) to determine the reference pose corresponding to the second image. The reference poses of other first images are sequentially determined based on the reference pose corresponding to the second image.

In a possible implementation mode, multiple non-collinear target points may be selected from the second image. Image position coordinates of the target points in the second image are marked. Geographical position coordinates of the target points, for example, latitude and longitude coordinates of practical geographical positions of the target points, are acquired.

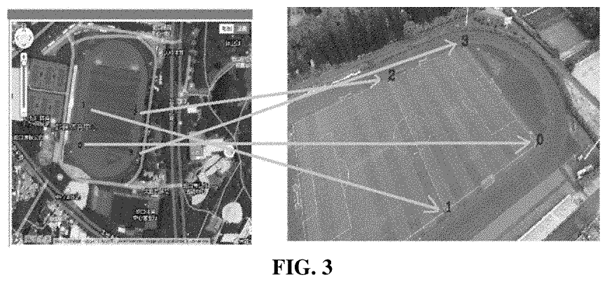

FIG. 3 is a schematic diagram of target points according to embodiments of the disclosure. As shown in FIG. 3, the right side in FIG. 3 is the second image acquired by the image acquisition device, and four target points (i.e., a point 0, a point 1, a point 2 and a point 3) are selected from the second image. For example, four vertexes of a stadium are selected as target points. Image position coordinates, for example, (x1, y1), (x2, y2), (x3, y3) and (x4, y4), of the four target points in the second image may be acquired.

In a possible implementation mode, geographical position coordinates, for example, latitude and longitude coordinates, of the four target points may be determined. The left side in FIG. 3 is a live map of the stadium, for example, a live map shot by a satellite. Latitude and longitude coordinates, for example, (x1′, y1′), (x2′, y2′), (x3′, y3′) and (x4′, y4′), of the four target points in each live map may be acquired.

In a possible implementation mode, the operations that the second homography matrix between the imaging plane of the image acquisition device when the second image is collected by the image acquisition device and the geographical plane is determined and the intrinsic matrix of the image acquisition device is determined include that: the second homography matrix between the imaging plane of the image acquisition device when the second image is collected by the image acquisition device and the geographical plane is determined according to image position coordinates and geographical position coordinates of the target points in the second image; and decomposition processing is performed on the second homography matrix to determine the intrinsic matrix of the image acquisition device.

In a possible implementation mode, the second homography matrix between the imaging plane of the image acquisition device and the geographical plane is determined according to the image position coordinates and geographical position coordinates of the target points. In an example, the second homography matrix between the imaging plane of the image acquisition device and the geographical plane may be determined according to a corresponding relationship between (x1, y1), (x2, y2), (x3, y3) (x4, y4) and (x1′, y1′), (x2′, y2′), (x3′, y3′) (x4′, y4′). For example, an equation set between each coordinate may be set up according to the coordinates, and the second homography matrix is obtained according to the equation set.

In a possible implementation mode, decomposition processing may be performed on the second homography matrix, and a relationship among the second homography matrix and the intrinsic matrix of the image acquisition device as well as the reference pose corresponding to the second image may be determined according to the following formula (1):

H=λK[R|T] (1).

H is the second homography matrix, λ is a feature value of H, K is the intrinsic matrix of the image acquisition device, [R|T] is an extrinsic matrix corresponding to the second image, R is a rotation matrix corresponding to the second image, and T is a displacement vector corresponding to the second image.

In a possible implementation mode, column vectors in the formula (1) may be represented as the following formula (2):

H=[h₁,h₂,h₃]=λK[r₁,r₂,t] (2).

h₁, h₂ and h₃ are column vectors of H respectively, r₁ and r₂ are column vectors of R, and t is a column vector of T.

In a possible implementation mode, the rotation matrix R is an orthogonal matrix, so that the following equation set (3) may be obtained according to the formula (2):

$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = 1 \\ {h}_{2}^{T} {K}^{- T} {K}^{- 1} {h}_{2} = 1\end{matrix} . \qquad ( 3 )$$

h₁^{T} is a transposed row vector of h₁, h₂^{T} is a transposed row vector of h₂, K^{-T} is a transposed matrix of K, and K⁻¹ is an inverse matrix of K.

In a possible implementation mode, the following equation set (4) may be obtained according to the equation set (3):

$$\{ \begin{matrix}{v}_{12}^{T} b = 0 \\ ( {v}_{11}^{T} - {v}_{12}^{T} ) b = 0\end{matrix} . \\ {v}_{ij}^{T} b = {h}_{i}^{T} {K}^{- T} {K}^{- 1} {h}_{j} ( i = 1 , 2 or 3 , and j = 1 , 2 or 3 ) . \qquad ( 4 )$$

In a possible implementation mode, singular value decomposition may be performed on the equation set (4) to obtain the intrinsic matrix of the image acquisition device. For example, a least square solution of the intrinsic matrix may be obtained.

In a possible implementation mode, in S15, the reference pose corresponding to the second image may be determined according to the intrinsic matrix and the second homography matrix. S15 may include that: an extrinsic matrix corresponding to the second image is determined according to the intrinsic matrix of the image acquisition device and the second homography matrix; and the reference pose corresponding to the second image is determined according to the extrinsic matrix corresponding to the second image.

In a possible implementation mode, the extrinsic matrix corresponding to the second image may be determined according to the formula (1) or formula (2). For example, the two sides of the formula (1) may be simultaneously multiplied by K⁻¹ and simultaneously divided by λ to obtain the extrinsic matrix [R|T] corresponding to the second image.

In a possible implementation mode, the rotation matrix R and displacement vector T in the extrinsic matrix are the reference pose corresponding to the second image.

In a possible implementation mode, in S16, the reference pose corresponding to each first image may be sequentially determined according to the reference pose corresponding to the second image. For example, the second image is a first image to be processed during processing of determining the reference poses of the at least one first image, and the reference pose corresponding to each subsequent first image may be sequentially determined according to the reference pose corresponding to the second image. S16 may include that: key point extraction processing is performed on a current first image and a next first image respectively to obtain a third key point in the current first image and a fourth key point, corresponding to the third key point, in the next first image, where the current first image is an image, corresponding to a known reference pose, in the at least one first image, the current first image includes the second image, and the next first image is an image adjacent to the current first image in the at least one first image; a third homography matrix between the current first image and the next first image is determined according to a corresponding relationship between the third key point and the fourth key point; and a reference pose corresponding to the next first image is determined according to the third homography matrix and the reference pose corresponding to the current first image.

In a possible implementation mode, key point extraction processing may be performed on the current first image and the next first image through a deep learning neural network, such as a convolutional neural network, respectively to obtain the third key point in the current first image and the fourth key point, corresponding to the third key point, in the next first image, or the third key point in the current first image and the fourth key point, corresponding to the third key point, in the next first image are obtained according to parameters, such as brightness, colors and the like, of pixels in the present next image and the next first image. The third key point and the fourth key point may represent the same group of points, but positions of the group of points in the current first image and the next first image may be different. A key point may be a point capable of representing a feature, such as a contour, a shape and the like, of a target object in an image. For example, the current first image is the second image (for example, the first one of the first images), and the second image and a second one of the first images may be input to the convolutional neural network to perform key point extraction processing to obtain multiple third key points and fourth key points in the second image and the second one of the first images respectively. For example, the second image is an image, shot by the image acquisition device, of a certain stadium, the third key points are multiple vertexes of the stadium, and vertexes of the stadium in the second one of the first images may be determined as the fourth key points. Furthermore, third position coordinates of the third key points in the second image and fourth position coordinates of the fourth key points in the second one of the first images may be acquired. Since the image acquisition device rotates by a certain angle between acquisition of the second image and acquisition of the second one of the first images, the third position coordinates and the fourth position coordinates are different. In an example, the current first image may also be any one of the first images, and the next first image is an image adjacent to the current first image. The current first image is not limited in the disclosure.

In a possible implementation mode, the image acquisition device rotates by a certain angle between acquisition of the current first image and acquisition of the next first image, namely the pose of the image acquisition device changes, the third homography matrix between the current first image and the next first image may be determined through the corresponding relationship between the third key point and the fourth key point, and the reference pose corresponding to the next first image may further be determined according to the reference pose corresponding to the current first image and the third homography matrix.

In a possible implementation mode, the operation that the third homography matrix between the current first image and the next first image is determined according to the corresponding relationship between the third key point and the fourth key point includes that: the third homography matrix between the current first image and the next first image is determined according to a third position coordinate of the third key point in the current first image and a fourth position coordinate of the fourth key point in the next first image. The third homography matrix between the current first image and the next first image may be determined according to the third position coordinate and the fourth position coordinate. In an example, a third homography matrix between the second image and a next first image may be determined.

In a possible implementation mode, the operation that the reference pose corresponding to the next first image is determined according to the third homography matrix and the reference pose corresponding to the current first image includes that: decomposition processing is performed on the third homography matrix to determine a value for a second pose change of the image acquisition device between acquisition of the current first image and acquisition of the next first image; and the reference pose corresponding to the next first image is determined according to the reference pose corresponding to the current first image and the second pose change.

In a possible implementation mode, decomposition processing may be performed on the third homography matrix, for example, the third homography matrix may be decomposed into column vectors, a linear equation set may be determined according to the column vectors of the third homography matrix, and the value for the second pose change, for example, the value for a pose angle change, between the current first image and the next first image may be obtained according to the linear equation set. In an example, the value for a pose angle change of the image acquisition device between shooting of the second image and shooting of the next first image may be determined.

In a possible implementation mode, the reference pose corresponding to the next first image may be determined according to the reference pose corresponding to the current first image and the value for the second pose change. For example, a pose angle corresponding to the next first image may be determined through the reference pose corresponding to the current first image and the value for the pose angle change, thereby obtaining the reference pose corresponding to the next first image. In an example, the reference pose corresponding to the second one of the first images may be determined according to the reference pose corresponding to the second image and the value for the pose angle change between the second image and the second one of the first images. In an example, according to the abovementioned manner, the third homography matrix may be determined based on second key points of the second one of the first images and a third one of the first images, a reference pose corresponding to the third one of the first images may be determined based on the second one of the first images, the third homography matrix and the reference pose corresponding to the second one of the first images, and a reference pose corresponding to a fourth one of the first images may be obtained based on the reference pose corresponding to the third one of the first images, until the reference poses corresponding to all the first images are acquired. That is, the reference poses corresponding to all the first images are obtained by sequential iteration from the first one of the first images to the last one of the first images.

In another example, the second image may be any one of the first images. After the reference pose corresponding to the second image is obtained, the reference poses corresponding to two first images adjacent to the second image may be obtained respectively, and the reference poses corresponding to two first images adjacent to the two first images may be obtained respectively according to the reference poses corresponding to the two first images adjacent to the second image, until the reference poses corresponding to all the first images are obtained. For example, the number of the first images may be 10, the second image is a fifth one of the first images, the reference poses corresponding to the fourth one and the sixth one of the first images may be obtained according to the reference pose corresponding to the second image, and furthermore, the reference poses corresponding to the third one and the seventh one of the first images may be continued to be obtained, until the reference poses corresponding to all the first images are obtained.

In such a manner, the reference pose corresponding to the first one of the first images may be obtained, the reference poses of all the first images may be iteratively determined according to the reference pose corresponding to the first one of the first images. It is unnecessary to perform calibration processing on each first image according to a complicated calibration method, so that the processing efficiency is improved.

In a possible implementation mode, the target pose, corresponding to any one image to be processed acquired by the image acquisition device, may be determined, namely the rotation matrix and displacement vector corresponding to the image to be processed are acquired. In an example, the image acquisition device may acquire any image to be processed, a pose corresponding to the image to be processed is unknown, namely the pose of the image acquisition device when the image to be processed is shot by the image acquisition device is unknown. A reference image matched with the image to be processed may be determined from the first images, and the pose corresponding to the image to be processed is determined according to the pose corresponding to the reference image. S11 may include that: feature extraction processing is performed on the image to be processed and at least one first image respectively to obtain first feature information of the image to be processed and second feature information of each first image. The reference image is determined from each first image according to a similarity between the first feature information and each piece of second feature information.

In a possible implementation mode, feature extraction processing may be performed on the image to be processed and each first image through the convolutional neural network respectively. In an example, the convolutional neural network may extract feature information of each image, for example, the first feature information of the image to be processed and the second feature information of each first image, and the first feature information and the second feature information may include feature maps, feature vectors and the like. The feature information is not limited in the disclosure. In another example, the first feature information of the image to be processed and the second feature information of each first image may also be determined according to parameters, such as colors, brightness and the like, of pixels in each first image and the image to be processed. A feature extraction processing manner is not limited in the disclosure.

In a possible implementation mode, the similarity (for example, a cosine similarity) between the first feature information and each piece of second feature information may be determined. For example, both the first feature information and the second feature information are feature vectors, the cosine similarity between the first feature information and each piece of second feature information may be determined. The first image corresponding to the second feature information with the highest cosine similarity with the first feature information is determined, namely the reference image is determined, and the reference pose corresponding to the reference image is obtained.

In a possible implementation mode, in S12, key point extraction processing may be performed on the image to be processed and the reference image respectively. For example, through the convolutional neural network, the first key point in the image to be processed may be extracted and the second key point, corresponding to the first key point, in the reference image may be obtained. Or, the first key point and the second key point may be determined through the parameters, such as the brightness, colors and the like, of the pixels in the image to be processed and the reference image. A manner for acquiring the first key point and the second key point is not limited in the disclosure.

In a possible implementation mode, in S13, the target pose corresponding to the image to be processed may be determined according to the corresponding relationship between the first key point and the second key point and the reference pose corresponding to the reference image. S13 may include that: the target pose of the image acquisition device when the image to be processed is collected by the image acquisition device is determined according to a first position coordinate of the first key point in the image to be processed, a second position coordinate of the second key point in the reference image and the reference pose corresponding to the reference image. That is, the target pose corresponding to the image to be processed may be determined according to the position coordinate of the first key point, the position coordinate of the second key point and the reference pose.

In a possible implementation mode, the operation that the target pose of the image acquisition device when the image to be processed is collected by the image acquisition device is determined according to the first position coordinate of the first key point in the image to be processed, the second position coordinate of the second key point in the reference image and the reference pose corresponding to the reference image includes that: a first homography matrix between the reference image and the image to be processed is determined according to the first position coordinate and the second position coordinate; decomposition processing is performed on the first homography matrix to determine a value for a first pose change of the image acquisition device between acquisition of the image to be processed and acquisition of the reference image; and the target pose is determined according to the reference pose corresponding to the reference image and the first pose change.

In a possible implementation mode, the first homography matrix between the reference image and the image to be processed may be determined according to the first position coordinate and the second position coordinate. For example, the first homography matrix between the reference image and the image to be processed may be determined according to a corresponding relationship between the first position coordinate of the first key point and the second position coordinate of the first key point.

In a possible implementation mode, decomposition processing may be performed on the first homography matrix, for example, the first homography matrix may be decomposed into column vectors, a linear equation set may be determined according to the column vectors of the first homography matrix, and a value for the first pose change, for example, a value for a pose angle change, between the reference image and the image to be processed may be obtained according to the linear equation set. In an example, the value for the pose angle change of the image acquisition device between shooting of the reference image and shooting of the image to be processed may be determined.

In a possible implementation mode, the target pose corresponding to the image to be processed may be determined according to the reference pose corresponding to the reference image and the value for the first pose change. For example, a pose angle corresponding to the image to be processed may be determined through the reference pose corresponding to the reference image and the value for the pose angle change, thereby obtaining the target pose corresponding to the image to be processed.

In such a manner, the target pose corresponding to the image to be processed may be determined through the reference pose corresponding to the reference image matched with the image to be processed and the first homography matrix, and the image to be processed is not required to be calibrated, so that the processing efficiency is improved.

In a possible implementation, feature extraction processing and key point extraction processing are implemented through the convolutional neural network. Before feature extraction processing and key point extraction processing are performed by use of the convolutional neural network, multi-task training may be performed on the convolutional neural network, namely feature extraction processing and key point extraction processing capabilities of the convolutional neural network are trained.

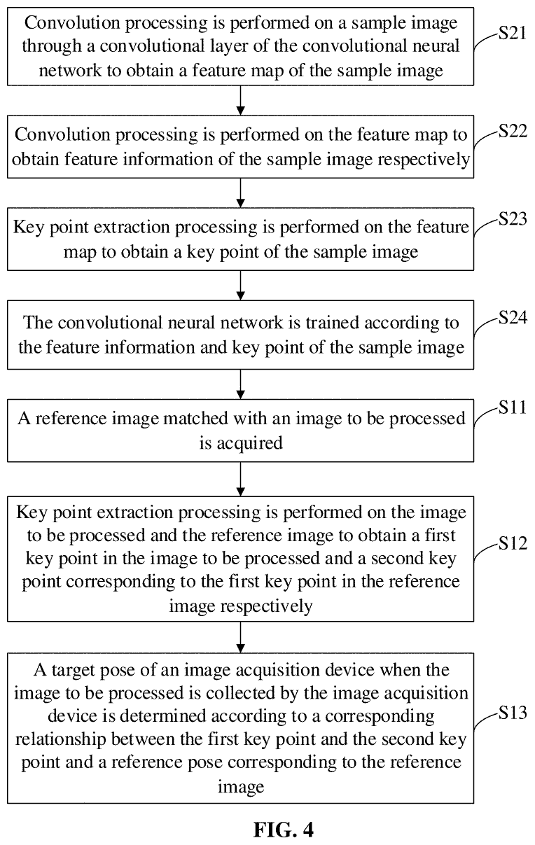

FIG. 4 is a flowchart of a pose determination method according to embodiments of the disclosure. As shown in FIG. 4, the method further includes the following operations.

In S21, convolution processing is performed on a sample image through a convolutional layer of the convolutional neural network to obtain a feature map of the sample image.

In S22, convolution processing is performed on the feature map to obtain feature information of the sample image respectively.

In S23, key point extraction processing is performed on the feature map to obtain a key point of the sample image.

In S24, the convolutional neural network is trained according to the feature information and key point of the sample image.

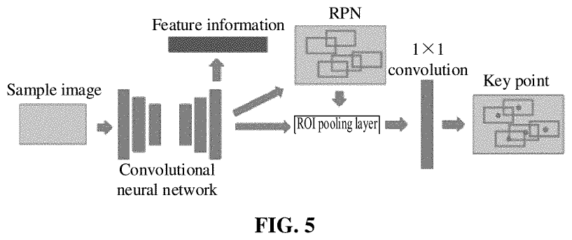

FIG. 5 is a schematic diagram of training a neural network according to embodiments of the disclosure. As shown in FIG. 5, the feature extraction processing capability of the convolutional neural network may be trained by use of the sample image.

In a possible implementation mode, in S21, convolution processing may be performed on the sample image through the convolutional layer of the convolutional neural network to obtain the feature map of the sample image.

In a possible implementation mode, the convolutional neural network may be trained by use of an image pair formed by sample images. For example, a similarity between the two sample images in the image pair may be marked (for example, marked with 0 if the images are completely different, and marked with 1 if the images are completely the same), feature maps of the two sample images in the image pair are extracted through the convolutional layer of the convolutional neural network respectively, and convolution processing may be performed on the feature maps to obtain feature information (for example, feature vectors) of the two sample images of the sample image pair respectively in S22.

In a possible implementation mode, in S23, the key point extraction processing capability of the convolutional neural network may be trained by use of a sample image with key point marking information (for example, marking information of the position coordinate of the key point). S23 may include that: the feature map is processed through an Region Proposal Network (RPN) of the convolutional neural network to obtain an Region Of Interest (ROI); and the ROI is pooled through an ROI pooling layer of the convolutional neural network, and convolution processing is performed through the convolutional layer to determine the key point of the sample image in the ROI.

In an example, the convolutional neural network may include the RPN and the ROI pooling layer. The feature map may be processed through the RPN to obtain the ROI, the ROI in the sample image may be pooled through the ROI pooling layer, and furthermore, convolution processing may be performed through the 1×1 convolutional layer to determine a position (for example, a position coordinate) of the key point in the ROI.

In a possible implementation mode, in S24, the convolutional neural network is trained according to the feature information and key point of the sample image.

In an example, when the feature extraction processing capability of the convolutional neural network is trained, the cosine similarity between feature information of the two sample images of the sample image pair may be determined. Furthermore, a first loss function for the feature extraction processing capability of the convolutional neural network may be determined according to the cosine similarity (there may be an error) output by the convolutional neural network and the marked similarity of the two sample images. For example, the first loss function for the feature extraction processing capability of the convolutional neural network may be determined according to a difference between the cosine similarity output by the convolutional neural network and the marked similarity between the two sample images.

In an example, when the key point extraction processing capability of the convolutional neural network is trained, a second loss function for the key point extraction processing capability of the convolutional neural network may be determined according to the position coordinate, output by the convolutional neural network, of the key point and the key point marking information. The position coordinate, output by the convolutional neural network, of the key point may have an error. For example, the second loss function for the key point extraction processing capability of the convolutional neural network may be determined according to the error between the position coordinate, output by the convolutional neural network, of the key point and the marking information of the position coordinate of the key point.

In a possible implementation mode, a loss function of the convolutional neural network may be determined according to the first loss function for the feature extraction processing capability of the convolutional neural network and the second loss function for the key point extraction processing capability of the convolutional neural network. For example, weighted summation may be performed on the first loss function and the second loss function. A manner for determining the loss function of the convolutional neural network is not limited in the disclosure. Furthermore, a network parameter of the convolutional neural network may be regulated according to the loss function. For example, the network parameter and the like of the convolutional neural network may be regulated through a gradient descent method. Such processing may be iteratively executed until a training condition is met. For example, processing of regulating the network parameter may be iteratively executed for a predetermined number of times. When the number of times for which the network parameter is regulated reaches the predetermined number of times, a feature extraction training condition is met, or, when the loss function of the convolutional neural network converges to a preset interval or is less than a preset threshold value, the training condition is met. When the convolutional neural network meets the training condition, training for the convolutional neural network is completed.

In a possible implementation mode, after training for the convolutional neural network is completed, the convolutional neural network may be adopted for key point extraction processing and feature extraction processing. In a process of performing key point extraction processing through the convolutional neural network, the convolutional neural network may perform convolution processing on an input image to obtain a feature map of the input image and perform convolution processing on the feature map to obtain feature information of the input image. An ROI of the feature map may also be obtained through the RPN, and the ROI may further be pooled through the ROI pooling layer to obtain a key point in the ROI. Through the RPN and the ROI pooling layer, the ROI of the image input to the convolutional neural network may be acquired in the training process or the key point extraction processing process, and the key point in the ROI may be determined, so that the key point determination accuracy is improved, and the processing efficiency is improved.

According to the pose determination method of the embodiments of the disclosure, the at least one first image may be obtained in the rotation process, the reference poses corresponding to all the first images may be iteratively determined according to the reference pose corresponding to the second image, and it is unnecessary to perform calibration processing on each first image, so that the processing efficiency is improved. Furthermore, the reference image matched with the image to be processed may be selected from the first images, and the pose corresponding to the image to be processed may be determined according to the reference pose corresponding to the reference image and the first homography matrix, so that the pose corresponding to any image to be processed may be determined when the image acquisition device rotates, the image to be processed is not required to be calibrated, and the processing efficiency is improved. Moreover, the convolutional neural network may acquire the ROI of the input image and determine the key point in the ROI in the training process or the key point extraction processing process, so that the key point determination accuracy is improved, and the processing efficiency is improved.

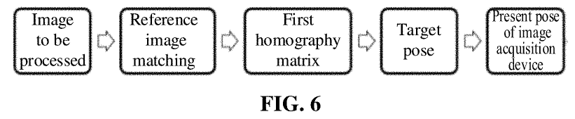

FIG. 6 is a schematic diagram of application of a pose determination method according to embodiments of the disclosure. As shown in FIG. 6, an image to be processed may be an image presently acquired by an image acquisition device, and a present pose of the image acquisition device may be determined according to the image to be processed.

In a possible implementation mode, the image acquisition device may rotate in advance along a pitching direction and/or a yawing direction and acquire at least one first image in a rotation process. The first one (a second image) in the at least one first image may be calibrated, multiple non-collinear target points may be selected from the second image, and a second homography matrix may be determined according to a corresponding relationship between image position coordinates of the target points in the second image and geographical position coordinates of the target points. The second homography matrix may be decomposed, and a least square solution of an intrinsic matrix of the image acquisition device may be acquired according to the formula (4).

In a possible implementation mode, a reference pose corresponding to the second image is determined through the formula (1) or (2) according to the intrinsic matrix of the image acquisition device and the second homography matrix. Furthermore, key point extraction processing may be performed on the second image and the second one of the first images through a convolutional neural network to obtain a third key point in the second image and a fourth key point in the second one of the first images, a third homography matrix between the second image and the second one of the first images may be obtained according to the third key point and the fourth key point, a reference pose corresponding to the second one of the first images may be obtained through the reference pose corresponding to the second image and the third homography matrix, and furthermore, a reference pose corresponding to the third one of the first images may be obtained through the reference pose corresponding to the second one of the first images and a third homography matrix between the second one of the first images and the third one of the first images. Such processing may be iteratively executed to determine reference poses corresponding to all the first images.

In a possible implementation mode, feature extraction processing may be performed on the image to be processed and each first image through the convolutional neural network to obtain first feature information of the image to be processed and second feature information of each first image respectively, a cosine similarity between the first feature information and each piece of second feature information may be determined, and the first image corresponding to the second feature information with the highest cosine similarity with the first feature information is determined as a reference image matched with the image to be processed.

In a possible implementation mode, key point extraction processing may be performed on the image to be processed and the reference image through the convolutional neural network to obtain a first key point in the image to be processed and a second key point, corresponding to the first key point, in the reference image respectively. A first homography matrix between the reference image and the image to be processed is determined according to the first key point and the second key point.

In a possible implementation mode, a target pose corresponding to the image to be processed, i.e., a pose (i.e., the present pose) of the image acquisition device when the image to be processed is shoot by the image acquisition device, may be determined according to the reference pose corresponding to the reference image and the first homography matrix.

In a possible implementation mode, through the pose determination method, a pose of the image acquisition device at any moment may be determined, and a visual region of the image acquisition device may also be predicted according to the pose. Furthermore, through the pose determination method, a basis may be provided for predicting a position of any point on a plane relative to the image acquisition device and predicting a motion velocity of a target object on the plane.

It can be understood that each method embodiment mentioned in the disclosure may be combined to form combined embodiments without departing from principles and logics. For saving the space, elaborations are omitted in the disclosure.

In addition, the disclosure also provides a pose determination device, an electronic device, a computer-readable storage medium and a program. All of them may be configured to implement any pose determination method provided in the disclosure. Corresponding technical solutions and descriptions refer to the corresponding records in the method part and will not be elaborated.

It can be understood by those skilled in the art that, in the method of the specific implementation modes, the writing sequence of each operation does not mean a strict execution sequence and is not intended to form any limit to the implementation process and a specific execution sequence of each step should be determined by functions and probable internal logic thereof.

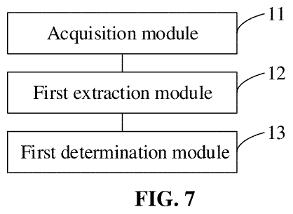

FIG. 7 is a block diagram of a pose determination device according to embodiments of the disclosure. As shown in FIG. 7, the device includes an acquisition module 11, a first extraction module 12 and a first determination module 13.

The acquisition module 11 is configured to acquire a reference image matched with an image to be processed, the image to be processed and the reference image being acquired by an image acquisition device, the reference image having a corresponding reference pose and the reference pose being configured to represent a pose of the image acquisition device when the reference image is collected by the image acquisition device.

The first extraction module 12 is configured to perform key point extraction processing on the image to be processed and the reference image to obtain a first key point in the image to be processed and a second key point, corresponding to the first key point, in the reference image respectively.

The first determination module 13 is configure to determine, according to a corresponding relationship between the first key point and the second key point and the reference pose corresponding to the reference image, a target pose of the image acquisition device when the image to be processed is collected by the image acquisition device.

In a possible implementation mode, the acquisition module is further configured to:

perform feature extraction processing on the image to be processed and at least one first image respectively to obtain first feature information of the image to be processed and second feature information of each of the at least one first image, the at least one first image being sequentially acquired by the image acquisition device in a rotation process; and

determine, according to a similarity between the first feature information and each piece of second feature information, the reference image from each of the at least one first image.

In a possible implementation mode, the device further includes a second determination module, a third determination module and a fourth determination module.

The second determination module is configured to determine a second homography matrix between an imaging plane of the image acquisition device when a second image is collected by the image acquisition device and a geographical plane and determine an intrinsic matrix of the image acquisition device, the second image being any one image in at least one first image and the geographical plane being a plane where geographical position coordinates of target points are located.

The third determination module is configured to determine a reference pose corresponding to the second image according to the intrinsic matrix and the second homography matrix.

The fourth determination module is configured to determine a reference pose corresponding to each of the at least one first image according to the reference pose corresponding to the second image.

In a possible implementation mode, the second determination module is further configured to:

determine, according to an image position coordinate and geographical position coordinates of the target points in the second image, the second homography matrix between the imaging plane of the image acquisition device when the second image is collected by the image acquisition device and the geographical plane, the target points being multiple non-collinear points in the second image; and

perform decomposition processing on the second homography matrix to determine the intrinsic matrix of the image acquisition device.

In a possible implementation mode, the third determination module is further configured to:

determine an extrinsic matrix corresponding to the second image according to the intrinsic matrix of the image acquisition device and the second homography matrix; and

determine the reference pose corresponding to the second image according to the extrinsic matrix corresponding to the second image.

In a possible implementation mode, the fourth determination module is further configured to:

perform key point extraction processing on a current first image and a next first image respectively to obtain a third key point in the current first image and a fourth key point, corresponding to the third key point, in the next first image, where the current first image is an image, corresponding to a known reference pose, in the at least one first image, the current first image includes the second image, and the next first image is an image adjacent to the current first image in the at least one first image;

determine a third homography matrix between the current first image and the next first image according to a corresponding relationship between the third key point and the fourth key point; and

determine a reference pose corresponding to the next first image according to the third homography matrix and the reference pose corresponding to the current first image.

In a possible implementation mode, the fourth determination module is further configured to:

determine the third homography matrix between the current first image and the next first image according to a third position coordinate of the third key point in the current first image and a fourth position coordinate of the fourth key point in the next first image.

In a possible implementation mode, the fourth determination module is further configured to:

perform decomposition processing on the third homography matrix to determine a value for a second pose change of the image acquisition device between acquisition of the current first image and acquisition of the next first image; and

determine the reference pose corresponding to the next first image according to the reference pose corresponding to the current first image and the value for the second pose change.

In a possible implementation mode, the first determination module is further configured to:

determine, according to a first position coordinate of the first key point in the image to be processed, a second position coordinate of the second key point in the reference image and the reference pose corresponding to the reference image, the target pose of the image acquisition device when the image to be processed is collected by the image acquisition.

In a possible implementation mode, the first determination module is further configured to:

determine a first homography matrix between the reference image and the image to be processed according to the first position coordinate and the second position coordinate;

perform decomposition processing on the first homography matrix to determine a value for a first pose change of the image acquisition device between acquisition of the image to be processed and acquisition of the reference image; and

determine the target pose according to the reference pose corresponding to the reference image and the value for the first pose change.

In a possible implementation mode, the reference pose corresponding to the reference image includes a rotation matrix and displacement vector of the image acquisition device when the reference image is acquired by the image acquisition device, and the target pose corresponding to the image to be processed includes a rotation matrix and displacement vector of the image acquisition device when the image to be processed is acquired by the image acquisition device.

In a possible implementation mode, feature extraction processing and key point extraction processing are implemented through a convolutional neural network.

The device further includes a first convolution module, a second convolution module, a second extraction module and a training module.

The first convolution module is configured to perform convolution processing on a sample image through a convolutional layer of the convolutional neural network to obtain a feature map of the sample image.

The second convolution module is configured to perform convolution processing on the feature map to obtain feature information of the sample image respectively.

The second extraction module is configured to perform key point extraction processing on the feature map to obtain a key point of the sample image.

The training module is configured to train the convolutional neural network according to the feature information and key point of the sample image.

In a possible implementation mode, the second extraction module is further configured to:

process the feature map through an RPN of the convolutional neural network to obtain an ROI; and

pool the ROI through an ROI pooling layer of the convolutional neural network and perform convolution processing through the convolutional layer to determine the key point of the sample image in the ROI.

In some embodiments, functions or modules of the device provided in the embodiments of the disclosure may be configured to execute the method described in the above method embodiments and specific implementation thereof may refer to the descriptions about the method embodiments and, for simplicity, will not be elaborated herein.

The embodiments of the disclosure also disclose a computer-readable storage medium, in which computer program instructions are stored, the computer program instructions being executed by a processor to implement the method. The computer-readable storage medium may be a nonvolatile computer-readable storage medium.

The embodiments of the disclosure disclose an electronic device, which includes a processor and a memory configured to store instructions executable for the processor, the processor being configured for the method.

The electronic device may be provided as a terminal, a server or a device in another form.

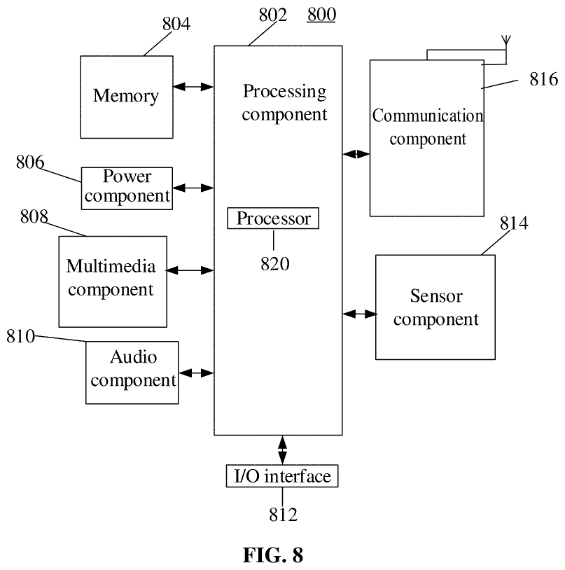

FIG. 8 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment and a PDA.

Referring to FIG. 8, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In the exemplary embodiment, a nonvolatile computer-readable storage medium is also provided, for example, a memory 804 including computer program instructions. The computer program instructions may be executed by a processor 820 of an electronic device 800 to implement the abovementioned method.

The embodiments of the disclosure also disclose a computer program product, which includes computer-readable codes, the computer-readable codes running in a device to enable a processor in the device to execute instructions configured to implement the method provided in any embodiment.

The computer program product may specifically be implemented through hardware, software or a combination thereof. In an optional embodiment, the computer program product is specifically embodied as a computer storage medium. In another optional embodiment, the computer program product is specifically embodied as a software product, for example, a Software Development Kit (SDK).

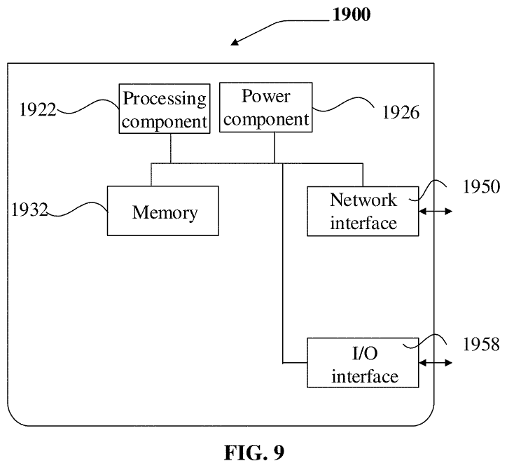

FIG. 9 is a block diagram of an electronic device 1900 according to an exemplary embodiment. For example, the electronic device 1900 may be provided as a server. Referring to FIG. 9, the electronic device 1900 includes a processing component 1922, further including one or more processors, and a memory resource represented by a memory 1932, configured to store instructions executable for the processing component 1922, for example, an application program. The application program stored in the memory 1932 may include one or more than one module of which each corresponds to a set of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to concatenate the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In the exemplary embodiment, a nonvolatile computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium, in which computer-readable program instructions configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. A pose determination method, comprising:
acquiring a reference image matched with an image to be processed, the image to be processed and the reference image being acquired by an image acquisition device, the reference image having a corresponding reference pose and the reference pose being configured to represent a pose of the image acquisition device when the reference image is collected by the image acquisition device;
performing key point extraction processing on the image to be processed and the reference image to obtain a first key point in the image to be processed and a second key point, corresponding to the first key point, in the reference image respectively; and
determining, according to a corresponding relationship between the first key point and the second key point and the reference pose corresponding to the reference image, a target pose of the image acquisition device when the image to be processed is collected by the image acquisition device.

2. The method of claim 1, wherein acquiring the reference image matched with the image to be processed comprises:
performing feature extraction processing on the image to be processed and at least one first image respectively to obtain first feature information of the image to be processed and second feature information of each of the at least one first image, the at least one first image being sequentially acquired by the image acquisition device in a rotation process; and
determining, according to a similarity between the first feature information and each piece of second feature information, the reference image from each of the at least one first image.

3. The method of claim 2, further comprising:
determining a second homography matrix between an imaging plane of the image acquisition device when a second image is collected by the image acquisition device and a geographical plane, and determining an intrinsic matrix of the image acquisition device, the second image being any one image in at least one first image and the geographical plane being a plane where geographical position coordinates of target points are located;
determining, according to the intrinsic matrix and the second homography matrix, a reference pose corresponding to the second image; and
determining, according to the reference pose corresponding to the second image, a reference pose corresponding to each of the at least one first image.

4. The method of claim 3, wherein determining the second homography matrix between the imaging plane of the image acquisition device when the second image is collected by the image acquisition device and the geographical plane and determining the intrinsic matrix of the image acquisition device comprises:
determining, according to image position coordinates and geographical position coordinates of the target points in the second image, the second homography matrix between the imaging plane of the image acquisition device when the second image is collected by the image acquisition device and the geographical plane the target points being multiple non-collinear points in the second image; and
performing decomposition processing on the second homography matrix to determine the intrinsic matrix of the image acquisition device.

5. The method of claim 4, wherein determining, according to the intrinsic matrix and the second homography matrix, the reference pose corresponding to the second image comprises:
determining, according to the intrinsic matrix of the image acquisition device and the second homography matrix, an extrinsic matrix corresponding to the second image; and
determining, according to the extrinsic matrix corresponding to the second image, the reference pose corresponding to the second image.

6. The method of claim 3, wherein determining, according to the reference pose corresponding to the second image, the reference pose corresponding to each of the at least one first image comprises:
performing key point extraction processing on a current first image and a next first image respectively to obtain a third key point in the current first image and a fourth key point, corresponding to the third key point, in the next first image, wherein the current first image is an image, corresponding to a known reference pose, in the at least one first image, the current first image comprises the second image, and the next first image is an image adjacent to the current first image in the at least one first image;
determining, according to a corresponding relationship between the third key point and the fourth key point, a third homography matrix between the current first image and the next first image; and
determining, according to the third homography matrix and the reference pose corresponding to the current first image, a reference pose corresponding to the next first image.

7. The method of claim 6, wherein determining the third homography matrix between the current first image and the next first image according to the corresponding relationship between the third key point and the fourth key point comprises:
determining the third homography matrix between the current first image and the next first image according to a third position coordinate of the third key point in the current first image and a fourth position coordinate of the fourth key point in the next first image.

8. The method of claim 6, wherein determining the reference pose corresponding to the next first image according to the third homography matrix and the reference pose corresponding to the current first image comprises:
performing decomposition processing on the third homography matrix to determine a value for a second pose change of the image acquisition device between acquisition of the current first image and acquisition of the next first image; and
determining, according to the reference pose corresponding to the current first image and the value for the second pose change, the reference pose corresponding to the next first image .

9. The method of claim 1, wherein determining, according to the corresponding relationship between the first key point and the second key point and the reference pose corresponding to the reference image, the target pose of the image acquisition device when the image to be processed is collected by the image acquisition device comprises:
determining, according to a first position coordinate of the first key point in the image to be processed, a second position coordinate of the second key point in the reference image and the reference pose corresponding to the reference image, the target pose of the image acquisition device when the image to be processed is collected by the image acquisition device.

10. The method of claim 9, wherein determining, according to the first position coordinate of the first key point in the image to be processed, the second position coordinate of the second key point in the reference image and the reference pose corresponding to the reference image, the target pose of the image acquisition device when the image to be processed is collected by the image acquisition device comprises:
determining, according to the first position coordinate and the second position coordinate, a first homography matrix between the reference image and the image to be processed;
performing decomposition processing on the first homography matrix to determine a value for a first pose change of the image acquisition device between acquisition of the image to be processed and acquisition of the reference image; and
determining, according to the reference pose corresponding to the reference image and the value for the first pose change, the target pose.

11. The method of claim 1, wherein the reference pose corresponding to the reference image comprises a rotation matrix and displacement vector of the image acquisition device when the reference image is acquired by the image acquisition device, and the target pose corresponding to the image to be processed comprises a rotation matrix and displacement vector of the image acquisition device when the image to be processed is acquired by the image acquisition device.

12. The method of claim 1, wherein feature extraction processing and key point extraction processing are implemented through a convolutional neural network, and
the method further comprises:
performing convolution processing on a sample image through a convolutional layer of the convolutional neural network to obtain a feature map of the sample image;
performing convolution processing on the feature map to obtain feature information of the sample image respectively;
performing key point extraction processing on the feature map to obtain a key point of the sample image; and
training the convolutional neural network according to the feature information and key point of the sample image.

13. The method of claim 12, wherein performing key point extraction processing on the feature map to obtain the key point of the sample image comprises:
processing the feature map through a Region Proposal Network (RPN) of the convolutional neural network to obtain a Region Of Interest (ROI); and
pooling the ROI through an ROI pooling layer of the convolutional neural network, and performing convolution processing through the convolutional layer to determine the key point of the sample image in the ROI.

14. An electronic device, comprising:
a processor; and
a memory, configured to store instructions executable for the processor.
wherein when the instructions stored in the memory are executed by the processor, the processor is configured to:
acquire a reference image matched with an image to be processed, the image to be processed and the reference image being acquired by an image acquisition device, the reference image having a corresponding reference pose and the reference pose being configured to represent a pose of the image acquisition device when the reference image is collected by the image acquisition device;
perform key point extraction processing on the image to be processed and the reference image to obtain a first key point in the image to be processed and a second key point, corresponding to the first key point, in the reference image respectively; and
determine, according to a corresponding relationship between the first key point and the second key point and the reference pose corresponding to the reference image, a target pose of the image acquisition device when the image to be processed is collected by the image acquisition device.

15. The electronic device of claim 14, wherein the processor is further configured to:
perform feature extraction processing on the image to be processed and at least one first image respectively to obtain first feature information of the image to be processed and second feature information of each of the at least one first image, the at least one first image being sequentially acquired by the image acquisition device in a rotation process; and
determine, according to a similarity between the first feature information and each piece of second feature information, the reference image from each of the at least one first image.

16. The electronic device of claim 15, the processor is further configured to:
determine a second homography matrix between an imaging plane of the image acquisition device when a second image is collected by the image acquisition device and a geographical plane and determine an intrinsic matrix of the image acquisition device, the second image being any one image in at least one first image and the geographical plane being a plane where geographical position coordinates of target points are located;
determine, according to the intrinsic matrix and the second homography matrix, a reference pose corresponding to the second image; and
determine, according to the reference pose corresponding to the second image, a reference pose corresponding to the at least one first image.

17. The electronic device of claim 16, wherein the processor is further configured to:
determine, according to an image position coordinate and geographical position coordinates of the target points in the second image, the second homography matrix between the imaging plane of the image acquisition device when the second image is collected by the image acquisition device and the geographical plane, the target points being multiple non-collinear points in the second image; and
perform decomposition processing on the second homography matrix to determine the intrinsic matrix of the image acquisition device.

18. The electronic device of claim 17, wherein the processor is further configured to:
determine, according to the intrinsic matrix of the image acquisition device and the second homography matrix, an extrinsic matrix corresponding to the second image; and
determine, according to the extrinsic matrix corresponding to the second image, the reference pose corresponding to the second image.

19. The electronic device of claim 16, wherein the processor is further configured to:
perform key point extraction processing on a current first image and a next first image respectively to obtain a third key point in the current first image and a fourth key point, corresponding to the third key point, in the next first image, wherein the current first image is an image, corresponding to a known reference pose, in the at least one first image, the current first image comprises the second image, and the next first image is an image adjacent to the current first image in the at least one first image;
determine, according to a corresponding relationship between the third key point and the fourth key point, a third homography matrix between the current first image and the next first image; and
determine, according to the third homography matrix and the reference pose corresponding to the current first image, a reference pose corresponding to the next first image.

20. A non-transitory computer-readable storage medium, in which computer program instructions are stored, the computer program instructions being executed by a processor to perform:
acquiring a reference image matched with an image to be processed, the image to be processed and the reference image being acquired by an image acquisition device, the reference image having a corresponding reference pose and the reference pose being configured to represent a pose of the image acquisition device when the reference image is collected by the image acquisition device;
performing key point extraction processing on the image to be processed and the reference image to obtain a first key point in the image to be processed and a second key point, corresponding to the first key point, in the reference image respectively; and
determining, according to a corresponding relationship between the first key point and the second key point and the reference pose corresponding to the reference image, a target pose of the image acquisition device when the image to be processed is collected by the image acquisition device.
